(19) United States
(12) Patent Application Publication
(10) Pub. No.: US 2008/0244378 A1
(43) Pub. Date: Oct. 2, 2008

(54) Information processing device, information processing system, information processing method, program, and storage medium

(75) Inventors: Mang Chen, Shanghai (CN); Bo Wu, Shanghai (CN); Yadong Wu, Shanghai (CN); Chen Xu, Shanghai (CN); Ning Le, Shangai (CN)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/002,671

(22) Filed: Dec. 18, 2007

(30) Foreign Application Priority Data
Mar. 30, 2007 (CN) 200710090671.1

(51) Int. Cl. G06F 17/21

(52) U.S. Cl. 715/226

(57) ABSTRACT

An information processing device includes: a feature extracting section for extracting, as format information, a format feature of a process-target document from image data of the process-target document, on which filling-in spaces of plural items are printed; a document recognizing section for comparing the format information of the process-target document with registered format information stored in a storage device, and specifying a registered document that corresponds to the process-target document, the registered format information regarding format features of registered documents; a data acquiring section for converting characters in the image data of the process-target document into text data; and a distributing section for grouping the image data and text data of the characters into plural groups according to a separation rule that is set for the registered document, the characters being written in the fill-in spaces of the items of the process-target document, and for transmitting the different groups to different external devices. With this, information such as personal information to be protected can be processed, preventing an operator dealing with the information from obtaining the whole information.

This Nonprovisional application claims priority under 35 U.S.C. §119(a) on Patent Application No. 200710090671.1 filed in the People's Republic of China on Mar. 30. 2007, the entire contents of which are hereby incorporated by reference.

### FIELD OF THE INVENTION

The present invention relates to an information processing device, an information processing system, information processing method, program, and storage medium for use in character recognition error correction of personal information, for example.

### BACKGROUND OF THE INVENTION

Conventionally, data recording of a hand-written document into a database is carried out by reading the hand-written document with a character reading device such as an OCR (Optical Character Reader) or the like and then converting the hand-written characters into text data. In this case, the OCR or a character recognition error correction device performs character recognition error correction, based on meanings of words and grammars. However, there is a limit in accuracy of such a machine-performed character recognition error correction. Therefore, a person (operator) should perform character recognition error correction in a man-machine interaction manner at a final stage.

In the character recognition error correction, character recognition errors, which are made by the character reading device, are corrected by the operator, for example, by comparing a photo-scanned image and a character-recognized data (which is read by the character reading device) of the hand-written document displayed on a screen on a device for the character recognition error correction. This method is very efficient in character recognition error correction performed in a large scale.

Patent Documents 1 to 6 disclose this kind of conventional arts.

Patent Documents 1 to 3 disclose character recognition error correction methods based on man-machine interaction. In the methods described in Patent Documents 1 to 3, a paper document is converted into an image document. Then, the image documents are segmented into character images of respective characters. The character images are recognized by OCR thereby converting them into electric text (text data). This text data is compared with the corresponding character images.

Patent Documents 4 and 5 disclose character recognition error correction methods based on syntactical and grammatical rules. In the methods described in Patent Documents 4 and 5, a text is compared with a reference pattern based on linguistic information such as syntaxes and grammars. If a part contradicting with the reference pattern is found, this part is corrected manually.

Patent Document 6 discloses a text protecting technique. In Patent Document 6, a text is watermarked so as to carry watermark information. This is utilized in encryption, tracing, owner-recognition, and countermeasures against illegal distribution of texts.
Patent Document 1: Specification of Chinese Patent Application Publication, No. 1426017 (Application No. 01144254.9; “Method and System for character recognition error of plural electric texts”)
Patent Document 2: Specification of Chinese Patent Application Publication, No. 1383516 (Application No. 01801889.0; “System for constructing Chinese character by using one-to-one method”)
Patent Document 3: Specification of Chinese Patent Application Publication, No. 1465017A (Application No. 02802508.3; “System for on-line character recognition error correction of text by using net server technique”)
Patent Document 4: Specification of Chinese Patent Application Publication, No. 1116342 (Application No. 94107348.3; “Method and system for automatic character recognition error correction of Chinese characters”)
Patent Document 5: Specification of Chinese Patent Application Publication, No. 1088011 (Application No. 93120009.1; “Method and device for pattern error correction of plural electric texts”)
Patent Document 6: Specification of Chinese Patent Application Publication, No. 1790420 (Application No. 20051025727.3; “Use of method capable of detecting number watermark in text, and device”)

Documents in some businesses contain a large amount of personal information. Such businesses are highly required to protect such personal information as safe as possible. In such businesses, the character recognition error correction that is manually performed deals with not general text data but text data containing a large amount of personal information. Therefore, the conventional character recognition error corrections performed in the man-machine interaction manner cannot be carried out without allowing the operator to access to the whole personal information. In view of the personal information protection, this is a loophole or a hidden peril. There has been proposed no technique effective to protect the personal information in the character recognition error correction that is manually performed.

### SUMMARY OF THE INVENTION

In view of the aforementioned problems, an object of the present invention is to provide an information processing device, information processing system, information processing method, program, and storage medium, each of which is capable of preventing an operator dealing with protection-target information (such as personal information) from obtaining the whole of information of a protection-target document, which contains the protection-target information.

In order to attain the object, an information processing device according to the present invention includes: a feature extracting section for extracting, as format information, a format feature of a process-target document from image data of the process-target document, on which filling-in spaces of plural items are printed; a document recognizing section for comparing the format information of the process-target document with registered format information stored in a storage device, and specifying a registered document that corresponds to the process-target document, the registered format information regarding format features of registered documents; a data converting section for converting characters in the image data of the process-target document into text data; and a distributing section for grouping the image data and text data of the characters into plural groups according to a separation rule that is set for the registered document, the characters being written in the fill-in spaces of the items of the process-target document, and for transmitting the different groups to different external devices.

A method according to the present invention for processing information includes: extracting, as format information, a format feature of a process-target document from image data of the process-target document, on which filling-in spaces of plural items are printed; comparing the format information of the process-target document with registered format information regarding format features of registered documents, so as to specify a registered document that corresponds to the process-target document; converting characters in the image data of the process-target document into text data; and grouping the image data and text data of the characters into plural groups according to a separation rule that is set for the registered document and transmitting the different groups to different external devices, the characters being written in the fill-in spaces of the items of the process-target document.

In these arrangements, the information processing device receives the image data of the process-target document on which the fill-in spaces of the plural items are printed. Then, the information processing device extracts, as the format information, the feature of the format of the process-target document. After that, the information processing device compares the format information with the registered format information regarding the feature of the formats of plural registered documents, thereby finding out a registered document that corresponds to the process-target document. Then, the information processing device converts, into the text data, the characters in the image data, which are written in the fill-in spaces on the process-target document. Next, by the information processing device, the image data and text data of the characters written in the fill-in spaces of the items on the process-target document are grouped into plural groups according to the separation rule that is set for the registered document that corresponds to the process-target document. Then, the information processing device transmits different groups to the different external devices (in such a way that not all groups are transmitted to one external group).

Therefore, the processing of the data of the process-target document by the external devices is carried out without allowing one external device to obtain the whole information of the process-target document, which contains the information to be protected. As a result, the information written in the process-target document is protected.

Moreover, one external device is provided with both the image data and text data of the characters written in a fill-in space of a predetermined item in a group. Thus, an operator can edit (correct) the text data at the external device, displaying on a displaying device of the external device, the text data and image data corresponding thereto. Thus, the editing (character recognition error correction) can be carried out with less burden and high efficiency.

### BRIEF DESCRIPTION OF THE DRAWINGS

FIG. 1 is a block diagram schematically illustrating an information processing system in one embodiment of the present invention.

FIG. 2 is a block diagram illustrating an information processing device illustrated in FIG. 1.

FIG. 3 is an explanatory view illustrating a travel accident insurance application form as an example of a document to be dealt with the information processing system according to the present embodiment of the present invention.

FIG. 4 is an explanatory view schematically illustrating a process carried out in a start-up table database creation mode in the image processing system illustrated in FIG. 1.

FIG. 5 is a flowchart illustrating an operation carried out in the start-up table database creation mode in the image processing system illustrated in FIG. 1.

FIG. 6 is an explanatory view illustrating how items, positions thereof, titles thereof, and content thereof are related with each other in a space of the start-up table illustrated in FIG. 3, in which relationship with an insured person is filled in.

FIG. 7(a) is an explanatory view illustrating groups of personal basic information, grouped by a data separating section illustrated in FIG. 2. FIG. 7(b) is an explanatory view illustrating groups of personal contact information, grouped by a data separating section illustrated in FIG. 2. FIG. 7(c) is an explanatory view illustrating groups of other information, grouped by a data separating section illustrated in FIG. 2.

FIG. 8 is an explanatory view schematically illustrating a process carried out in character recognition error correction mode in the information processing system illustrated in FIG. 1.

FIG. 9 is a flowchart illustrating an operation carried out in the character recognition error correction mode in the information processing system illustrated in FIG. 1.

### DESCRIPTION OF THE EMBODIMENTS

An information process system including an image processing device according to one embodiment of the present invention is described below referring to drawings.

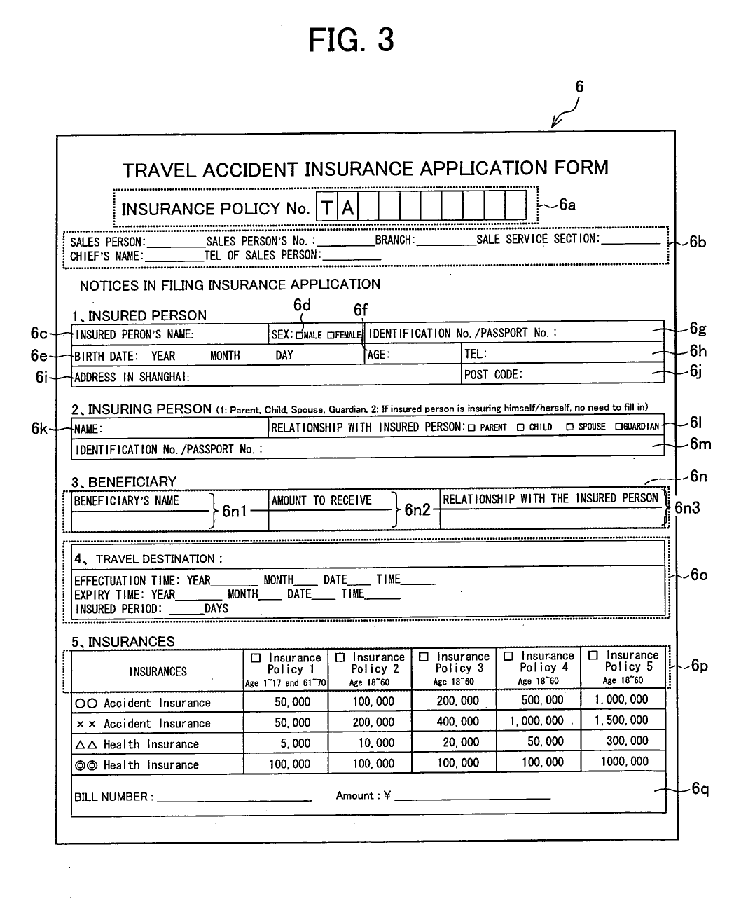

FIG. 3 is an explanatory view illustrating a travel accident insurance application form as an example of a document to be processed by an information processing system of the present embodiment. A process-target document 6, which is to be processed herein, is illustrated in FIG. 3. The process-target document 6 has: an insurance policy number space 6a, insurance sales staff information space 6b, insured person name space 6c, insured person sex space 6d, insured person birth date space 6e, insured person age space 6f, insured person ID number space 6g, insured person telephone number space 6h, insured person address space 6i, insured person post code space 6j, insuring person name space 6k, insured and insuring person's relationship space 6l, insuring person ID number 6m, beneficiary space 6n, travel destination space 6o, insurance space 6p, and bill information space 6q. Each space is framed and to be filled by hand-writing or ticking. The items explaining content to fill in is printed inside the frames. Thus, in the present embodiment, the process-target document 6 has a fill-in type table format having plural frames for the items to fill in.

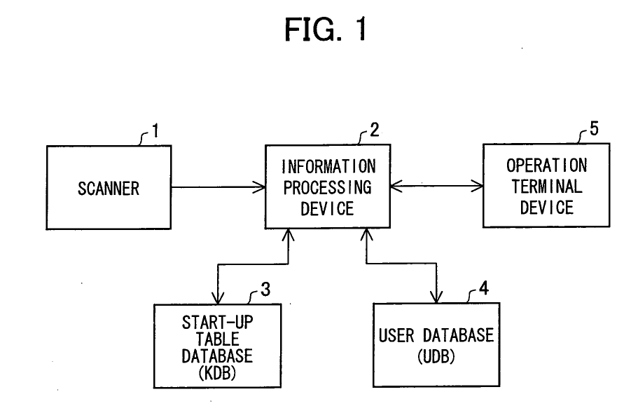

FIG. 1 is a block diagram schematically illustrating an information processing system of the present embodiment. As illustrated in FIG. 1, the information processing system includes a scanner (image reading device) 1, an information processing device 2, a start-up table database (KDB) 3, and a user database (UDB) 4, and an operation terminal device 5.

The scanner 1 reads an image hand-written or printed on the process-target document 6 and converts the image into image data. In the present embodiment, the process-target document 6 carries personal information, which is protection-target information (information to be protected). On the process-target document 6, tables are printed in advance. The personal information are filled in the tables by hand-writing.

In the start-up table database (storage device) 3, format information on start-up tables printed on various process-target documents 6 is stored in association with scan images of the start-up tables. Here, the “start-up tables” are tables printed on the process-target documents 6 and unfilled with personal information therein that is to be filled therein.

After subjected to character recognition error correction, data of a process-target document 6 is stored in the user database 4.

The operation terminal device (external device) 5 is used by an operator in performing character recognition error correction of the protection-target information. In the information processing system of the present invention, plural operation terminal devices 5 are provided.

The information processing system of the present embodiment can perform a start-up table database creation mode and a character recognition error correction mode. The start-up table database creation mode is used to create a database of start-up tables of various kinds in the start-up table database 3. Moreover, the character recognition error correction mode is used when the operator, using the operation terminal device 5, performs the character recognition error correction of data inputted via the scanner 1 and then processed with the information processing device 2.

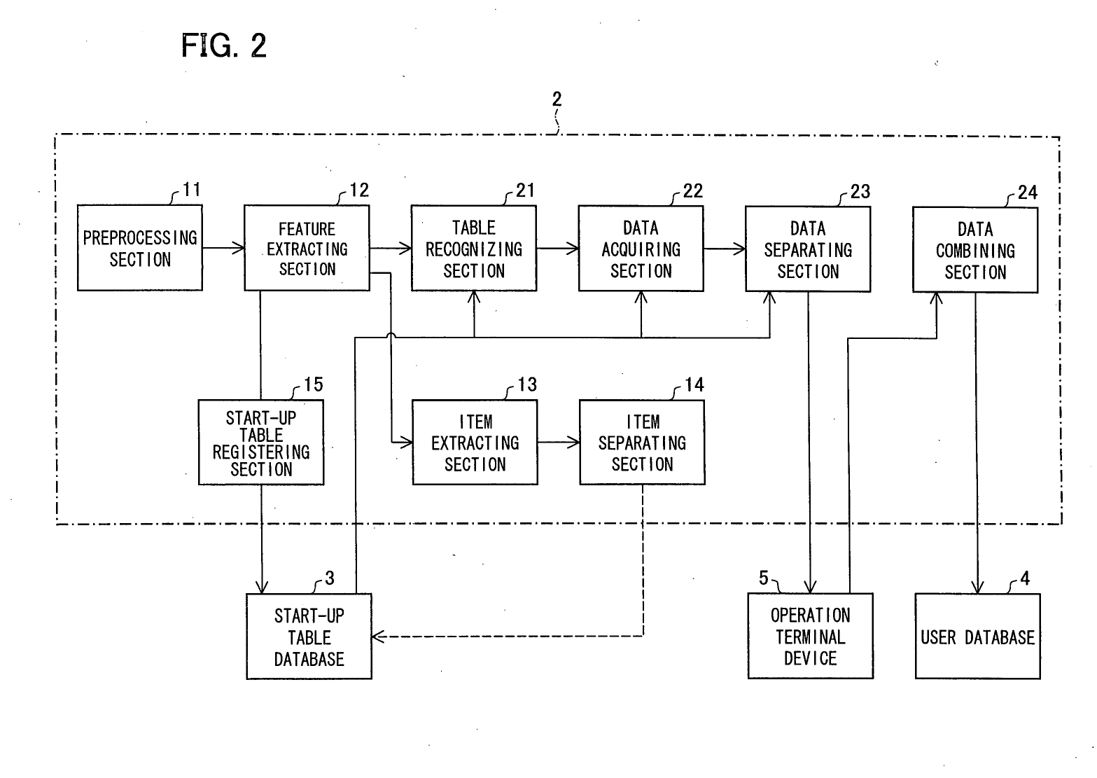

FIG. 2 is a block diagram illustrating a configuration of the information processing device 2. The information processing device 2 includes a preprocessing section 11, a feature extracting section 12, an item extracting section 13, an item separating section 14, a start-up table registering section 15, a table recognizing section (document recognizing section) 21, a data acquiring section 22, a data separating section (distributing section, data converting section) 23, and a data combining section 24.

The preprocessing section 11 performs preprocessing of the image read by the scanner 1. For example, the preprocessing section 11 performs noise reduction, skew correction, or the other process to the image read by the scanner 1.

The feature extracting section 12 extracts feature of the tables printed on the process-target document 6, thereby obtaining the format of the tables. In this case, Steps 1 to 4 described below are performed. In Step 1, positions of horizontal lines of the table are detected by projecting light on the image of the table horizontally. In Step 2, positions of vertical lines of the table are detected by projecting light on the image of the table vertically. In Step 3, intersections of the horizontal lines and the vertical lines are worked out. In Step 4, frames of the table are created based on the information thus obtained. Thus, the feature extracting section 12 acquires an arrangement of the frames (layout), specifically, a format of the table, the format indicating the frames of the tables and the positions of the frames.

The start-up table registering section 15 registers, in the start-up database 3, a start-up table in association with a scan image of the start-up table when a format of the start-up table is obtained by the feature extracting section 12 in the start-up table database creation mode.

The item extracting section 13 extracts an item printed on the process-target document 6. In the item extracting process, information of the item is acquired by using an OCR function. The information is a numeral reference, a position, a name, and content of the item.

By the item separating section 14, the items extracted by the item extracting section 13 are classified into groups. The result of the classification is referred to as a data separation rule in separating data by the data separating section 23.

The classes of the items are, for example, personal basic information, personal contact information, and the other information regarding the personal information. The classes of the items are set in personal information protection rule stored in the start-up database 3, for example. The item separating section 14 performs the classification (separation of the items) referring to the personal information protection rule.

The personal information protection rule is, for example, a rule for preventing an operator who deals with the process-target document 6, from obtaining the whole or the substantially whole of personal information of various kinds recited on the process-target document 6, or from acquiring highly important information among the personal information recited on the process-target document 6. The personal information protection rule is set as appropriate, depending on which kind of document the process-target document 6 is, what is recited therein, and/or how important the personal information is.

The information regarding the items in the table thus obtained by the item extracting section 13, and the result of the classification performed by the item separating section 14 are registered in the start-up table database 3 in association with the start-up table corresponding to them.

The table recognizing section 21 compares the format of the table (table to be recognized) of the process-target document 6 acquired by the feature extracting section 12, with the formats of the various start-up tables registered in the start-up table database 3. Via the comparison, the table recognizing section 21 finds a start-up table that corresponds to the table to be recognized.

The data acquiring section 22 coverts the image data inside the frames of the tables into text data (data of character codes) by the OCR function. In this case, the data acquiring section refers to information on the items of the table, the information including the item titles and positional information of the item.

By the data separating section 23, the text data inputted from the data acquiring section 22 is separated into groups according to a separation rule, which is set for the start-up table. For each start-up table, its own separation rule is set according to the result of the classification performed by the item separating section 14.

Moreover, by the data separating section 23, the image data of the table of the process-target document 6 read by the scanner 1 is separated according to the separation rule. In this case, the segments (groups) of the text data and the segments (groups) of the image data of the table are coincided with each other regarding the items of the tables, so that the text data and image data of the same items on the table of the process-target document 6 are grouped in the same group.

Furthermore, the data separating section 23 transmits the text data and the image data of different groups to the different operation terminal devices 5.

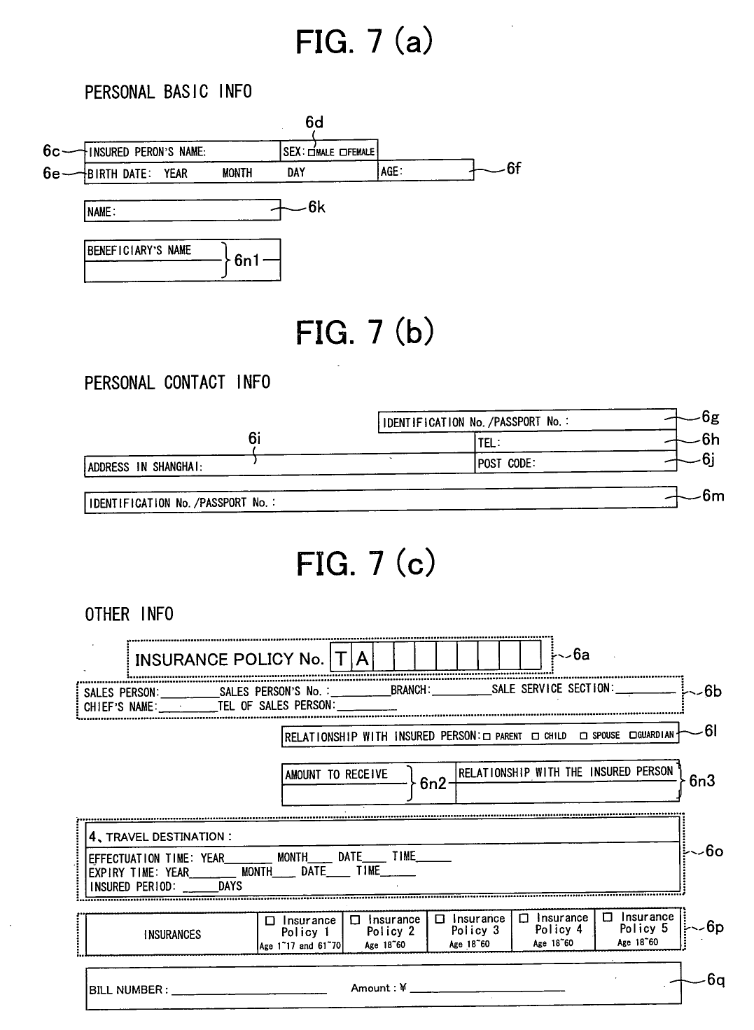

FIGS. 7(a) to 7(C) are explanatory views illustrating results of the data separating process of the data of the process-target document 6, illustrated in FIG. 3, performed by the data separating section 23. FIG. 7(a) illustrates personal basic information. FIG. 7(b) illustrates personal contact information. FIG. 7(c) illustrates other information. In the example illustrated in FIGS. 7(a) to 7(c), the groups of the personal basic information include the insured person name space 6c, insured person sex space 6d, insured person birth date space 6e, insured person age space 6f, insuring person name space 6k, and insured and beneficiary name space 6n 1. The groups of personal contact information include the insured person ID number space 6g, insured person telephone number space 6h, insured person address space 6i, insured person post code space 6j, and insuring person ID number 6m. The groups of the other information include insurance policy number space 6a, insurance sales staff information space 6b, insured and insuring person's relationship space 6l, amount-to-receive space 6n2 and beneficiary-and-insured-person's-relationship space 6n3 of the beneficiary space 6n, travel destination space 6o, insurance space 6p, and bill information space 6q.

The personal basic information includes, for example, a name of a person who filled the process-target document. The personal contact information includes, for example, information to identify the person, but other than the name. The other information includes, for example, information which is other than the personal basic information and the personal contact information, and which is to be filled in the process-target document 6.

By the data combining section 24, data subjected to the character recognition error correction and transmitted thereto from the operation terminal devices 5 is combined into one piece of data of the process-target document 6. The data of the process-target document 6 thus prepared via the combining process is equivalent to the image data of the process-target document 6 having been read by the scanner 1. Then, the data combining section 24 stores in the user database 4 the data of the document thus prepared via the combining process.

The data stored in the user database 4 is editable by operating a terminal device (managing device) connected to the user database 4.

In the following, the operation of the information processing system in the present embodiment of this configuration is described below.

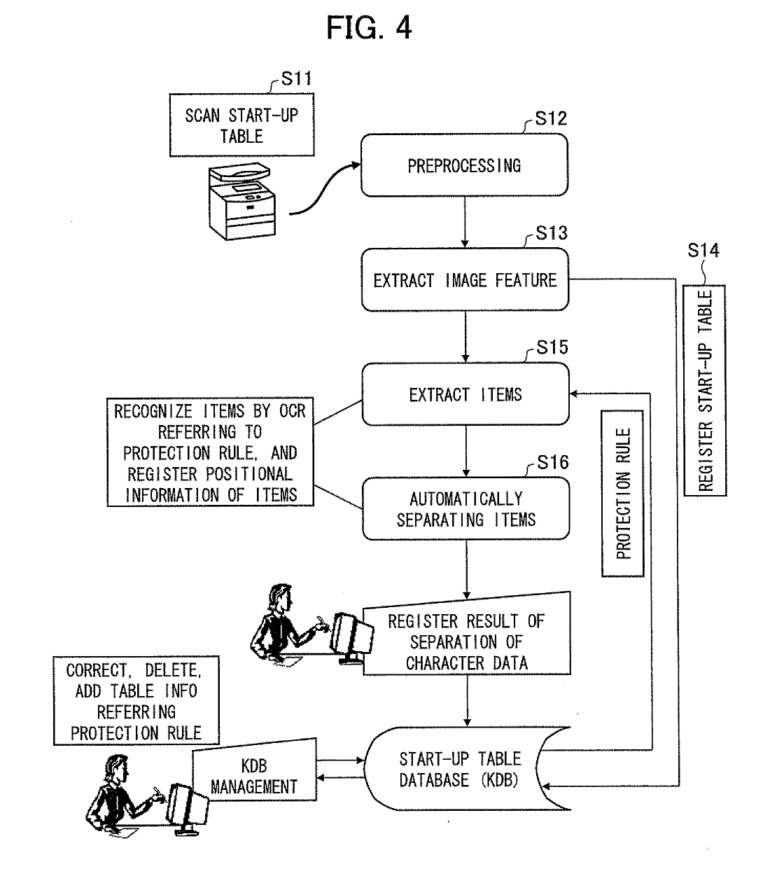

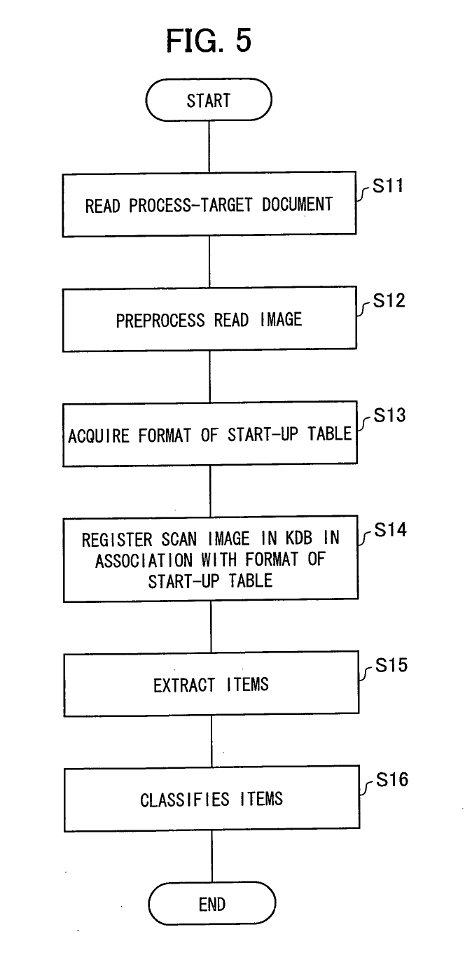

Firstly, the operation carried out in the start-up database creation mode is described referring to FIGS. 4 and 5. FIG. 4 is an explanatory view schematically illustrating the operation carried out in start-up database creation mode. FIG. 5 is a flowchart illustrating the operation of the information processing system in the start-up database creation mode.

In the start-up database creation mode, the operation to register the start-up tables of the various process-target documents 6 in the start-up table database 3 in advance is carried out. The start-up table database 3 stores the format information of the start-up tables in association with the scan image of the start-up tables.

In the start-up table database creation mode, the image of the start-up table printed on an unfilled process-target document 6 is read by the scanner 1, and digital image data thereof is created (S11). The image data is inputted in the information processing device 2.

The preprocessing section 11 of the information processing device 2 performs the preprocessing of the image read by the scanner 1 (S12). The preprocessing may be noise reduction, skew correction, or the like. As a result of this preprocessing, the read image becomes clearer and positioned straightly. The image data thus processed by the preprocessing section 11 is inputted in the feature extraction section 12.

The feature extracting section 12 extracts feature of the table (start-up table) printed on the process-target document 6, and finds out the format of the table (S13). Next, by the registering section 15 of the start-up table, the format of the start-up table acquired by the feature extracting section 12 is registered in the start-up database (KDB) in association with the scan image (image data) of the start-up table (S14), the scan image being inputted from the scanner 1.

Then, the item extracting section 13 extracts the items printed on the process-target document 6 (S15). In the item extraction process, the information of the items is acquired by using the OCR function. The information includes numeral references, position, item name, and content of the item.

The numeral reference is a sequence number attached to the item. The position of the item is coordinates, area, or the like in which the item is located. The item name is a title of the item, which is recognized from the character image. The content of the item is what is hand-written in the frame for the item. In the case of the start-up table, the content is nil (no write-down).

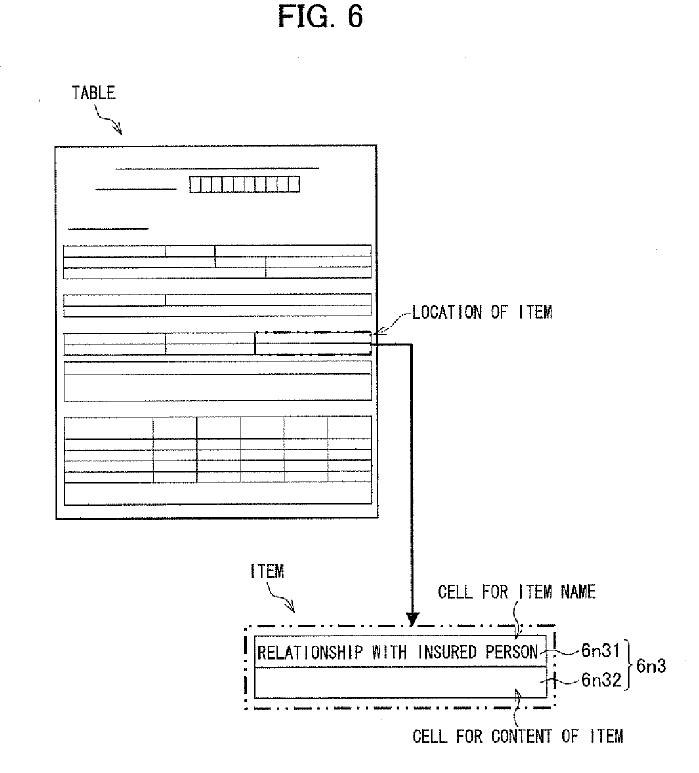

For example, in the process-target document 6 illustrated in FIG. 3, the beneficially space 6n has the beneficiary name space 6n1, amount-to-receive space 6n2, and beneficiary-and-insured-person's-relationship space 6n3. For example, the table (start-up table), item, position of the item, item name, and content of the item are related with each other in the beneficiary-and-insured-person's-relationship space 6n3, as illustrated in FIG. 6. The cell (frame) 6n32 for the content of the item is positioned under the cell(frame) 6n31 for the item name (in the case of FIG. 6) or at the right of the cell(frame) 6n31 for the item name.

Next, the item separating section 14 classifies the item extracted in the extraction process of the item (S16). Here, the item is classified based on, for example, the personal basic information, personal contact information, and the other information. The classes of the items are set in the personal information protection rule stored in the start-up table database 3. The item separating section 14 performs the classification of the items (separation of the items) referring to the information protection rule.

These operations are carried out for a plurality of the process-target documents 6, which the information processing system deals with. Then, the start-up table database creation mode is ended.

After the process of the item separating section 14 is finished, the operator, by operating the terminal device connected with the information processing device 2 and the start-up table database 3, registers (a) the information on the items of the table which information is extracted by the item extracting section 13 and includes the position of the table and item name, and (b) the result of the classification of the items (separation of the items) performed by the item separating section 14, in the start-up table database 3 in association with the start-up table registered. The registering operation may be automatically carried out by a section of the information processing device 2. For example, the item separating section 14 may perform the registering operation automatically. Moreover, in the registration operation, the operator checks whether the classification of the item (separation of the items) performed by the item separating section 14 is in compliance with the information protection rule. If not, the operator corrects the registration.

Moreover, the operator may, by operating the terminal device connected with the start-up table database 3, appropriately correct the information of the start-up table referring to the information protection rule, the information being registered in the start-up table database 3.

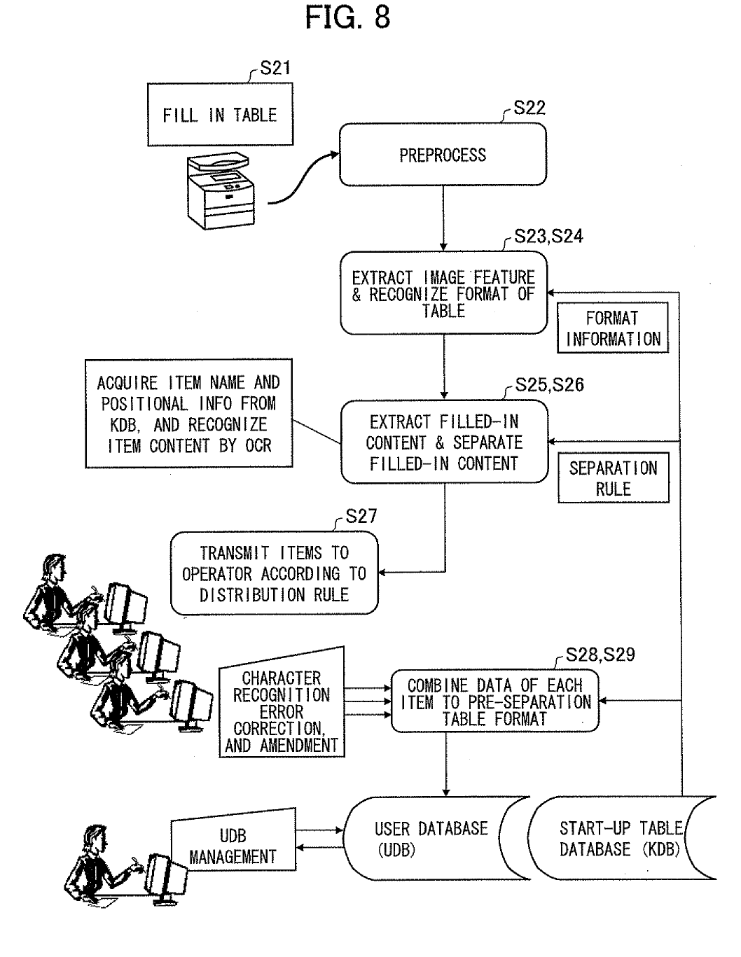

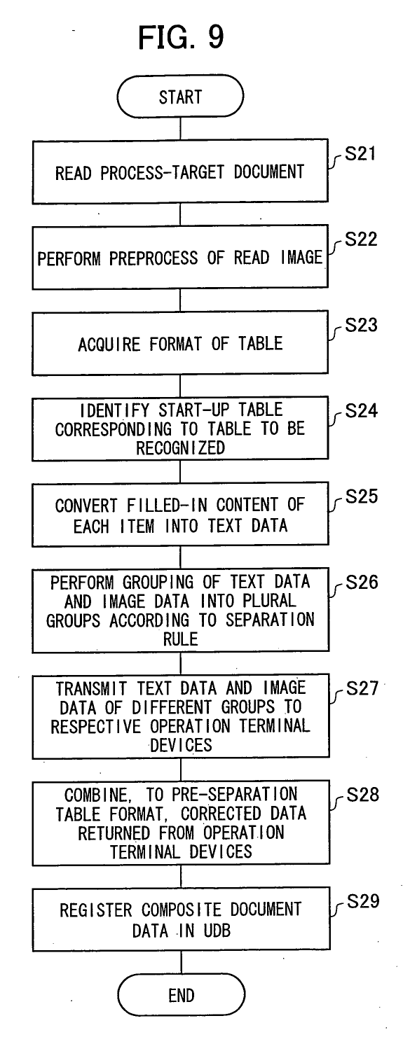

Next, the character recognition error correction mode is described below referring to FIGS. 8 and 9. FIG. 8 is an explanatory view schematically illustrating the process carried out in the character recognition error correction mode. FIG. 9 is a flowchart illustrating the operation of the operation of the information processing system in the character recognition error correction mode.

In the character recognition error correction mode, the personal information of the items is extracted out of the process-target document 6 in which the personal information is hand-written, and then the extracted personal information is converted into the text data. Next, the text data is separated into plural groups according to the separation rule, which is the result of the classification of the items (separation of the items) performed by the item separating section 14. Then, the text data of the groups are transmitted to the different operation terminal devices 5. Moreover, the text data returned from the respective operation terminal devices 5 after being treated with the character recognition error correction are combined into the document data corresponding to the read image data of the process-target document 6. Then, the document data is registered in the user database 4.

In the character recognition error correction mode, as illustrated in FIG. 9, the process-target document 6 on which the personal information is hand-written is read by the scanner 1, thereby creating the binary image data thereof (S21). The image data is inputted to the information processing device 2.

The preprocessing section 11 of the information processing device 2 performs the preprocessing (noise reduction, skew correction or the like) of the image read by the scanner 1 (S22). This causes the read image to be clearer and straight. The image data processed by the preprocessing section 11 is inputted into the feature extracting section 12.

The feature extracting section 12 extracts the feature of the table printed on the process-target document 6, thereby finding the format of the table (S23).

The table recognizing section 21 compares the table (table to be recognized) obtained by the feature extraction section 12, with the various start-up table registered in the start-up table database 3, whereby the table recognizing section 21 identifies the start-up table that corresponds to (matches with) the table that is to be recognized (S24).

Next, the data acquiring section 22 refers to the item name and positional information regarding the start-up table identified by the table recognizing section 21, and converts, by using the OCR function, the image data inside the frames of the items into the text data (S25). In this way, the images of the hand-written portions of the process-target documents 6 is converted into the text data.

Next, according to the separation rule, which is the result of the classification of the items (separation of the items) performed by the item separating section 14, the data separating section 23 separates the text data into plural groups according to the separation rule as the items are grouped. Moreover, according to the separation rule, the image data of the table of the process-target document 6, which is read by the scanner 1, is divided into plural groups as the items are grouped. (S26) In this case, the text data and the image data are separated in the same manner. That is, the text data and the image data of the same item of the process-target document 6 are grouped into the same group.

Next, the data separating section 23 transmits (distributes) the text data and the image data of different groups to the different operation terminal devices 5 (S27).

After the separated text data and the separated image data are transmitted to an operation terminal device 5 from the information processing device 2, the operator who is in charge of operating the operation terminal device 5 performs the character recognition error correction of the text data, comparing the text data with the image data. After that, the text data subjected to the character recognition error correction is returned together with the image data from the operation terminal device 5 to the information processing device 2.

After receiving the text data subjected to the character recognition error correction, the data combining section 24 of the information processing device 2 combines the data received from the respective operation terminal devices 5, thereby forming the document data containing the personal information, the document data restoring the shape of the process-target document 6. The document data corresponds to the image data of the process-target document read in advance by the scanner 1. The document data thus created is then registered in the user database 4. (S29).

The document data registered in the user database 4 can be edited as appropriate by an operator who operates the terminal (managing device) connected to the user database 4.

As described above, the information processing system of the present embodiment divides the data of the personal information contained in the process-target document 6 and provides the different portions of the data to different operation terminal devices 5. In this case, the data of different groups grouped according to a predetermined information protection rule will not be transmitted to the same operation terminal device 5. This will prevent the operators operating the respective operation terminals from obtaining the whole of the personal information contained in the process-target document 6, even though the operators can have fragments of the personal information contained in the process-target document 6. In the character recognition error correction of the data contained in the process-target document 6, which is performed by the operation terminal device 5, this arrangement makes it possible to ensure the protection of the personal information.

Moreover, as described above, the data of the personal information is divided in groups. Then, the data of different groups are transmitted to the different operation terminal devices 5, and processed therein. With this arrangement, it is possible to perform the protection of the personal information even if the grouping is not based on a strict rule.

Moreover, if it is so arranged that an operation terminal device 5 receives data of the same kind of group for every document, the operator operating the operation terminal device 5 can familiarize oneself with the operation. Therefore, this arrangement makes it possible to deal with a large number of the process-target document 6 efficiently.

Moreover, in the character recognition error correction performed by the operation terminal device 5 can be carried out, the text data and image data of one item in the table of the process-target document 6 can be concurrently displayed on the screen of the device operation terminal device 5. Therefore, the operator can perform the character recognition error correction without moving his viewpoint between the document and the screen. Thus, he/she can perform it effectively and less fatiguingly.

Moreover, the information processing system can automatically acquire, from the start-up table of the image data, the format information of the start-up table of the process-target document 6 and the information regarding the items contained in the start-up table. Thus, it is not necessary to manually input such information. This attains a lower cost and a higher processing speed in the character recognition error correction.

Moreover, the information processing system is arranged such that the start-up table is registered in the start-up database 3 in advance. This makes it possible to automatically identify the kind of the table printed on the process-target document 6, referring to the format information registered in the start-up table database 3. Thus, it is not necessary to identify the kind of the table manually by the operator, and to input the result of the identification.

While the present embodiment discusses an example in which the process-target document 6 is a travel accident insurance application form containing personal information, the present invention is not limited to the field of the insurance, and is also applicable to process-target documents 6 in banking, medical, official registry fields and the like so as to protect personal information contained therein. Moreover, the process-target document 6 is not limited to a document having personal information, and may be a document a corporation information. In this case, the information protection rule is set according to the corporation information.

Finally, each block of the information processing device 2 illustrated in FIG. 2 may be constituted by hardware logic or software logic by using a CPU as follows.

That is, the information processing device 2 includes: (i) a CPU (central processing unit) for executing instructions of a control program realizing various functions; (ii) a ROM (read only memory) for storing the above programs; (iii) a RAM (random access memory) for expanding the program; (iv) a storage device (storage medium), such as a memory, storing the programs and various types of data; and the like. Therefore, the object of the present invention can be achieved by: (i) providing, in the information processing device 2, a storage medium which stores a computer-readable program code (executable program, intermediate code program, a source program) of the control program for controlling the information processing device 2 that are software for realizing the functions, and (ii) causing a computer (CPU, or MPU) of the information processing device 2 to read out and execute the program code stored in the storage medium.

Examples of the storage medium encompass: tapes such as a magnetic tape and a cassette tape; magnetic disks such as a floppy® disk and a hard disk; disks such as a CD-ROM (compact disk read only memory), a magnetic optical disk (MO), a mini disk (MD), a digital video disk (DVD), and a CD-Recordable (CD-R); and the like. Further, the storage medium may be: a card such as an IC card (inclusive of a memory card) or an optical card; a semiconductor memory such as a mask ROM, an EPROM (electrically programmable read only memory), an EEPROM (electrically erasable programmable read only memory), or a flash ROM; or the like.

Further, the information processing device 2 may be so arranged as to be connectable to a communication network, and the program code may be supplied to the information processing device 2 via the network. The communication network is not particularly limited. Specific examples thereof encompass: the Internet, intranet, extranet, LAN (local area network), ISDN (integrated services digital network), VAN (value added network), CATV (cable TV) communication network, virtual private network, telephone network, mobile communication network, satellite communication network, and the like. Further, a transmission medium constituting the communication network is not particularly limited. Specific examples thereof are: (i) a wired channel using an IEEE1394, a USB (universal serial bus), a power-line communication, a cable TV line, a telephone line, an ADSL line, or the like; or (ii) a wireless channel using IrDA, infrared rays used for a remote controller, Bluetooth®, IEEE802.11, HDR (High Data Rate), a mobile phone network, a satellite connection, a terrestrial digital network, or the like. Note that the present invention can be realized by a form of a computer data signal (a series of data signals) embedded in a carrier wave realized by electronic transmission of the program code.

As described above, the information processing device of the present invention may comprise a data combining section for combining the text data returned from each external device so as to create document data that corresponds to the format of the process-target document.

With this arrangement, the data combining section creates the document data that corresponds to the format of the pre-separation process-target document, by combining the text data returned thereto from each external device. Therefore, the data of the process-target document subjected to the character recognition process can be obtained as editable document data.

The information processing device may be arranged such that the character extracting section registers in the storage device the extracted format as format information regarding the registered document, the extracted format being extracted from the image data of the process-target document.

With this arrangement, the character extracting section registers in the storage device the format information extracted from the image data of the process-target document, the format information being registered as the format information of the registered document. Thus, the format information regarding the registered document can be obtained and registered in the storage device.

The information processing device may comprise: an item extracting section for extracting the items written in the fill-in spaces on the process-target document; and an item separating section for creating the separation rule according to a predetermined information protection rule, the separation rule being a rule on which the items extracted by the item extracting section are grouped into the plural groups.

With this arrangement, the items in the fill-in spaces of the process-target document, which are extracted by the item extracting section, are grouped into plural groups according to the separation rule created by the item separating section according to the predetermined information protection rule. With this arrangement, the information (information to be protected) written in the process-target document can be protected appropriately based on the information protection rule.

The information processing device may be arranged such that the information protection rule is a personal information protection rule for preventing leakage of personal information.

The information processing device may be arranged such that the personal information protection rule is a basis of the separation rule for grouping the items into groups of personal basic information, person contact information, and other information, the personal basic information including a name of a person filled in the document-target document, the person contact information including information which is other than the name but identifies the person, and the other information being information which is other than the personal basic information and the person contact information but is filled in the process-target document.

A information processing system according to the present invention comprises any one of the information processing devices and a start-up table database as the storage device, the start-up table database storing the information protection rule in advance.

In this arrangement, the information protection rule is stored in the start-up table database (storage device) in advance. With this arrangement, the item separating section can easily create the separation rule referring to the information protection rule stored in the start-up table database (storage device), the separation rule being for grouping the items into plural groups.

The information processing system may comprise: an image reading device for reading an image of a document so as to create image data of the image of the document; a user database for storing therein the document data created by the data combining section; and plural operation terminal devices as the external devices, the plural operation terminal devices being capable of editing the text data.

With this arrangement, the information process system makes it easy to perform the series of operations: the reading of the image of the process-target document, conversion of the obtained image data into text data, distribution of the data to plural operation terminal devices, combining of the processed data, and storing of the combined data.

The present invention is not limited to the description of the embodiments above, but may be altered by a skilled person within the scope of the claims. An embodiment based on a proper combination of technical means disclosed in different embodiments is encompassed in the technical scope of the present invention.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. An information processing device comprising:
a feature extracting section for extracting, as format information, a format feature of a process-target document from image data of the process-target document, on which filling-in spaces of plural items are printed;
a document recognizing section for comparing the format information of the process-target document with registered format information stored in a storage device, and specifying a registered document that corresponds to the process-target document, the registered format information regarding format features of registered documents;
a data converting section for converting characters in the image data of the process-target document into text data; and
a distributing section for grouping the image data and text data of the characters into plural groups according to a separation rule that is set for the registered document, the characters being written in the fill-in spaces of the items of the process-target document, and for transmitting the different groups to different external devices.

2. The information processing device as set forth in claim 1, comprising:
a data combining section for combining the text data returned from each external device so as to create document data that corresponds to the format of the process-target document.

3. The information processing device as set forth in claim 1, comprising:
a start-up table registering section for registering in the storage device the format information extracted from the image data of the process-target document, the format information being registered as the format information of the registered document.

4. The information processing device as set forth in claim 1, comprising:
an item extracting section for extracting the items written in the fill-in spaces on the process-target document; and
an item separating section for creating the separation rule according to a predetermined information protection rule, the separation rule being a rule on which the items extracted by the item extracting section are grouped into the plural groups.

5. The information processing device as set forth in claim 4, wherein the information protection rule is a personal information protection rule for preventing leakage of personal information.

6. The information processing device as set forth in claim 5, wherein the personal information protection rule is a basis of the separation rule for grouping the items into groups of personal basic information, person contact information, and other information, the personal basic information including a name of a person filled in the document-target document, the person contact information including information which is other than the name but identifies the person, and the other information being information which is other than the personal basic information and the person contact information but is filled in the process-target document.

7. An information processing system comprising:
an information processing device including
a feature extracting section for extracting, as format information, a format feature of a process-target document from image data of the process-target document, on which filling-in spaces of plural items are printed;
a document recognizing section for comparing the format information of the process-target document with registered format information stored in a storage device, and specifying a registered document that corresponds to the process-target document, the registered format information regarding format features of registered documents;
a data converting section for converting characters in the image data of the process-target document into text data; and
a distributing section for grouping the image data and text data of the characters into plural groups according to a separation rule set for the registered document, the characters being written in the fill-in spaces of the items of the process-target document, and for transmitting the different groups to different external devices, and
a start-up table database as the storage device, the start-up table database storing the information protection rule in advance.

8. The information processing system as set forth in claim 7, comprising:
an image reading device for reading an image of a document so as to create image data of the image of the document;
a user database for storing therein the document data created by the data combining section; and
plural operation terminal devices as the external devices, the plural operation terminal devices being capable of editing the text data.

9. A method of processing information, comprising:
extracting, as format information, a format feature of a process-target document from image data of the process-target document, on which filling-in spaces of plural items are printed;
comparing the format information of the process-target document with registered format information regarding format features of registered documents, so as to specify a registered document that corresponds to the process-target document;
converting characters in the image data of the process-target document into text data; and
grouping the image data and text data of the characters into plural groups according to a separation rule that is set for the registered document, and transmitting the different groups to different external devices, the characters being written in the fill-in spaces of the items of the process-target document.

10. A program for causing a computer to function as each section of an information processing device as set forth in claim 1.

11. A computer-readable storage medium in which a program as set forth in claim 10 is recorded.
